(19) United States
(12) Patent Application Publication
(10) Pub. No.: US 2026/0213988 A1
(43) Pub. Date: Jul. 23, 2026

(54) TECHNOLOGIES TO SUPPORT UPLINK FREQUENCY-SELECTIVE PRECODING

(71) Applicant: Apple Inc., Cupertino, CA (US)

(72) Inventors: Haitong Sun, Saratoga, CA (US); Dan Wu, Beijing (CN); Chunxuan Ye, San Diego, CA (US); Dawei Zhang, Saratoga, CA (US); Wei Zeng, Saratoga, CA (US); Oghenekome Oteri, San Diego, CA (US); Ankit Bhamri, Munich (DE)

(73) Assignee: Apple Inc., Cupertino, CA (US)

(21) Appl. No.: 19/458,551

(22) Filed: Jan. 23, 2026

(30) Foreign Application Priority Data
Jan. 23, 2025 (WO) PCT/CN2025/074294

(51) Int. Cl. H04L 27/26; H04L 5/00

(52) U.S. Cl. CPC H04L 27/261; H04L 5/0044; H04L 5/0098

(57) ABSTRACT

The present application relates to technologies to support frequency-selective precoding for an uplink transmission, such as a physical uplink shared channel (PUSCH) and/or a physical uplink control channel (PUCCH). The PUSCH may be codebook-based or non-codebook-based. A user equipment (UE) may transmit a sounding reference signal (SRS) over multiple subbands with different precoders. Techniques for configuring multiple subbands for the uplink transmission and/or indicating precoders for the respective subbands are also described.

### CROSS-REFERENCE TO RELATED APPLICATION

This application is a U.S. Non-Provisional Patent Application that claims priority to PCT International Patent Application No. PCT/CN2025/074294, filed Jan. 23, 2025, which is herein incorporated by reference in its entirety for all purposes.

### TECHNICAL FIELD

This application relates generally to communication networks and, in particular, to technologies to support uplink frequency-selective precoding.

### BACKGROUND

In Fifth Generation (5G) Third Generation Partnership (3GPP) cellular networks, codebook-based and non-codebook-based transmission of uplink (UL) data is supported. Codebook-based transmission is typically used with a channel without downlink (DL)/UL reciprocity, e.g., frequency-domain duplexing (FDD) spectrum. Non-codebook-based transmission is typically used with a channel that has DL/UL reciprocity, such as time-domain duplexing (TDD) spectrum.

### BRIEF DESCRIPTION OF THE DRAWINGS

FIG. 1 illustrates an example of a network environment in accordance with some embodiments.

FIG. 2 illustrates an example of a sounding reference signal (SRS) resource with multiple subbands in accordance with some embodiments.

FIGS. 3A and 3B illustrate example configurations of subbands for SRS in accordance with some embodiments.

FIG. 4 illustrates an example of a two-step downlink control information (DCI) to schedule an uplink transmission, in accordance with some embodiments.

FIG. 5 illustrates an example of an operational flow/algorithmic structure in accordance with some embodiments.

FIG. 6 illustrates another example of an operational flow/algorithmic structure in accordance with some embodiments.

FIG. 7 illustrates another example of an operational flow/algorithmic structure in accordance with some embodiments.

FIG. 8 illustrates an example of a user equipment (UE) in accordance with some embodiments.

FIG. 9 illustrates an example of a base station in accordance with some embodiments.

### DETAILED DESCRIPTION

Embodiments of the present disclosure relate to, among other things, technologies to support frequency-selective precoding for an uplink transmission, such as a physical uplink shared channel (PUSCH) and/or a physical uplink control channel (PUCCH). The PUSCH may be codebook-based or non-codebook-based. In an example, a user equipment (UE) may transmit a sounding reference signal (SRS) over multiple subbands with different precoders. The UE may receive configuration information from the network to configure the subbands for the SRS. Embodiments further include techniques for configuring multiple subbands for the uplink transmission and/or indicating precoders for the respective subbands.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit

(ASIC), a field-programmable device (FPD) (e.g., a field-programmable gate array (FPGA), a programmable logic device (PLD), a complex PLD (CPLD), a high-capacity PLD (HCPLD), a structured ASIC, a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” “or “processing circuitry” as used herein refers to, is part of, or includes circuitry capable of carrying out a set of arithmetic or logical operations, and/or recording, storing, and/or transferring digital data. The term “processor circuitry” and “processing circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, device, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The UE can communicate with another UE or a network and the UE may be integrated with other devices and/or systems (e.g., in a vehicle).

The term “base station” as used herein refers to a device with radio communication capabilities, that is a device of a communications network (or, more briefly, network), and that may be configured as an access node in the communications network. The logical functionality and/or physical deployment of the base station may be distributed among various units (e.g., Central Unit (CU), Distributed Unit (DU), Remote Unit (RU), etc.) within a radio access network (RAN). A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, repeater on a communications satellite, etc.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

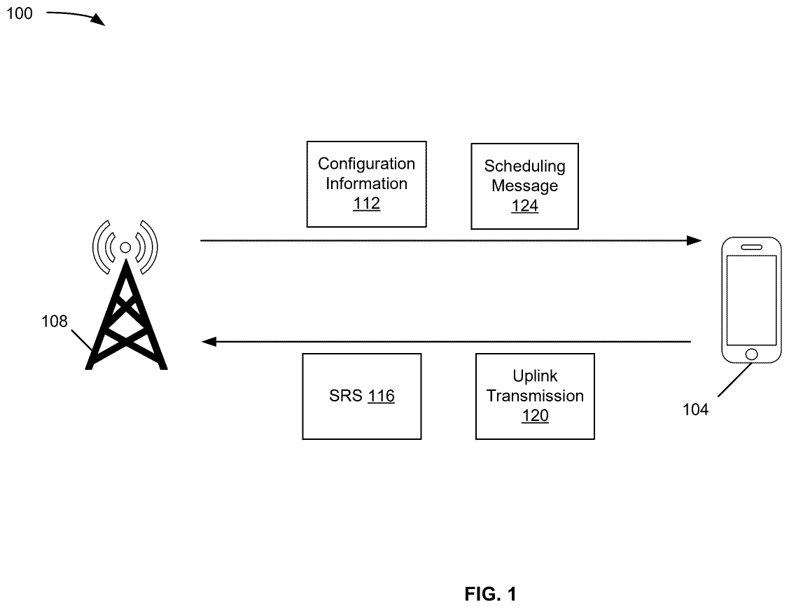

FIG. 1 illustrates a network environment 100, in accordance with some embodiments. The network environment 100 may include a UE 104 and a base station 108. The base station 108 provides a wireless access cell, for example, a Third-Generation Partnership Project (3GPP) New Radio (NR) cell, through which the UE 104 may communicate with the gNB. The base station 108 may include a set of transmission and reception points (TRPs). The UE 104 and the base station 108 may communicate over an interface compatible with 3GPP technical specifications, such as those that define Fifth-Generation (5G) NR system standards, Sixth-Generation (6G) standards, or the like. As used herein, the UE 104 and/or base station 108 can reference to the entire device or any logical or physical components of the device (e.g., transmitter, receiver, modem, application processor, processing circuitry, etc.).

Also further discussed herein, the base station 108 may transmit configuration information 112 to the UE 104. The configuration information 112 may configure subbands for a sounding reference signal (SRS) 116 and/or another uplink transmission 120 transmitted by the UE 104. The uplink transmission 120 may include, for example, a physical uplink shared channel (PUSCH) and/or a physical uplink control channel (PUCCH). The uplink transmission 120 may be codebook-based or non-codebook-based. In an example, the base station 108 transmits a scheduling message 124 (e.g., a downlink control information (DCI) or another suitable message) to schedule the uplink transmission 120. In some embodiments, some or all of the configuration information 112 may be included in the scheduling message 124. Some or all of the configuration information 112 may additionally or alternatively be transmitted separately from the scheduling message 124, such as via radio resource control (RRC) signaling and/or medium access control (MAC) signaling (e.g., in one or more MAC-control elements (MAC-CEs)).

The base station 108 may transmit information (for example, data and control signaling) in the downlink direction by mapping logical channels on the transport channels, then transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the base station 108 to allocate both uplink and downlink resources. The DCI may also be used to provide uplink power control commands, configure a slot format, or indicate that preemption has occurred.

The base station 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include a channel state information-reference signal (CSI-RS). The CSI-RS may be a multi-purpose downlink transmission signal that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

The UE 104 may transmit data and control information to the base station 108 using physical uplink channels. Different types of physical uplink channels are possible, including a PUCCH and a PUSCH. Whereas the PUCCH carries control information from the UE 104 to the base station 108, such as uplink control information (UCI), the PUSCH carries data traffic (e.g., end-user application data) and can carry UCI.

The UE 104 may also transmit one or more reference signals to the base station 108. For example, the UE 104 may transmit a SRS (e.g., SRS 116) to the base station 108. The SRS may be used by the network to determine one or more parameters for an uplink transmission of the UE 104, such as precoding information (e.g., a transmit precoding matrix (TPMI) and/or or SRS resource identifier (SRI)), rank indication (RI), and/or other parameters. The UE 104 may be configured with one or more SRS resource sets for transmission of respective SRSs. The individual SRS resource sets may have a configured usage, such as codebook, non-codebook, antenna switching, and/or beam management.

In an example, communications with the base station 108 can use channels in the frequency range 1 (FR1) band and/or frequency range 2 (FR2) band, although other frequency ranges are possible. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

The UE 104 can be located within a network coverage. In particular, the base station 108 may provide the network coverage with signaling (e.g., which may be carried by one or more beams). The network coverage may represent a cell or a portion of the cell that the base station 108 provides. The network coverage may provide network connections to multiple UEs, similar to the UE 104. These UEs may communicate with the base station 108 on both the uplink and the downlink based on channels available to them when the UEs are in the network coverage.

Transmission of uplink data (e.g., PUSCH) from the UE 104 to the network (e.g., base station 108) can support codebook-based operation and/or non-codebook-based operation. In codebook-based operation, the UE 104 transmits an SRS on one or more SRS resources with multiple SRS ports. The SRS resources may be included in an SRS resource set, e.g., with usage set to codebook. The network selects an SRS resource for the uplink transmission based on the received SRSs. The network indicates one or more parameters for the uplink transmission, such as TPMI and/or RI, with respect to the selected SRS resource. Codebook-based operation may generally be used in situations without DL/UL reciprocity, such as FDD spectrum.

In non-codebook operation, the UE 104 transmits an SRS on multiple SRS resources, with individual SRS resources being transmitted using a single port. In a message that schedules the uplink transmission (e.g., a DCI), the network indicates the SRS resource and/or port selected for the uplink transmission. The scheduling message may further indicate the RI and/or other parameters for the uplink transmission.

The non-codebook operation may generally be used in situations with good DL/UL reciprocity, such as with TDD spectrum. The UE 104 may estimate the DL channel based on one or more DL reference signals, such as CSI-RS. The UE 104 can assume that the UL channel is similar to the DL channel. Accordingly, the UE 104 may determine a preferred UL precoder based on the DL channel estimate. The UE 104 may transmit the SRS on the respective SRS resources with beam forming associated with different layers of the preferred UL precoder.

In 5G/NR systems, frequency-selective precoding is not supported for UL transmissions such as PUSCH and PUCCH. Accordingly, the same precoder is applied across the entire bandwidth of the UL transmission. Frequency-selective precoding for UL was considered unnecessary for 5G/NR since the UL typically operates at a lower signal-to-noise ratio (SNR) compared to DL (e.g., due to the difference in transmit power of a UE compared to a base station) and uses a smaller number of layers than DL.

In 6G and/or future systems, the UE 104 may be equipped with a larger number of antennas (e.g., 3 to 8 antennas), which may enable frequency-selective precoding to be implemented for UL transmissions. Frequency-selective precoding in the UL may provide increased diversity gain and/or enable adaptation to a frequency-selective channel (e.g., a channel with conditions that vary across the frequency spectrum, such as a delay spread). Channels with wide bandwidth and/or at high frequencies (e.g., FR2) may be especially frequency selective and thus may particularly benefit from frequency-selective precoding. However, embodiments herein are not limited to any particular frequency range or channel bandwidth.

Various embodiments herein provide technologies to support UL frequency-selective precoding. For example, embodiments provide techniques for non-codebook (reciprocity) UL data (PUSCH) transmission, codebook (non-reciprocity) UL data (PUSCH) transmission, and/or UL control (PUCCH) transmission.

In various embodiments, a plurality of subbands in the frequency domain may be configured for transmission of SRS and/or an uplink channel (e.g., PUSCH and/or PUCCH). For example, the UE may receive configuration information from the network to configure the subbands. Within an individual subband, the UE transmits the SRS and/or uplink channel with the same precoding. However, the UE may use different precoding for different subbands of the plurality of subbands.

With respect to SRS, the UE may choose the precoding to use for individual subbands of the SRS. Accordingly, the network may assume that all frequency subcarriers of a subband are transmitted with the same precoding, e.g., share the same antenna port and/or experience the same channel. However, the network may not assume that frequency subcarriers from different subbands are transmitted with the same precoding. Therefore, when estimating the UL channel, the network may perform filtering/averaging within individual subbands but not across different subbands.

The subbands with respective precoding for SRS transmission may facilitate scheduling of an uplink transmission (e.g. codebook-based PUSCH, non-codebook-based PUSCH, and/or PUCCH) with frequency-selective precoding. For example, the network may schedule the uplink transmission with different precoders in respective subbands.

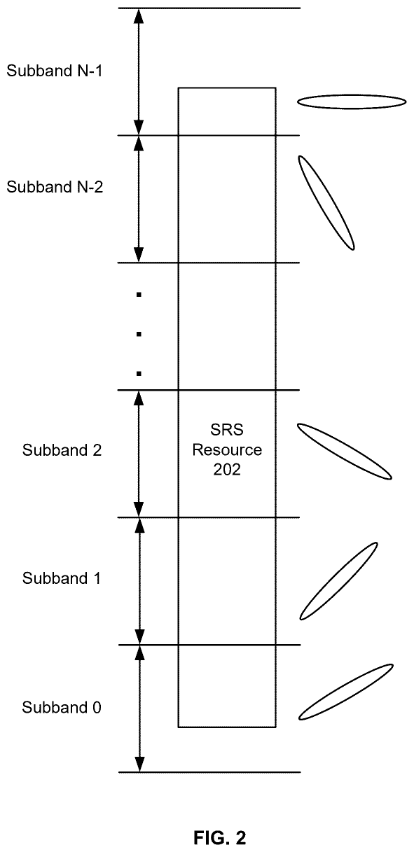

FIG. 2 illustrates an example of an SRS resource 202 divided into N subbands (e.g., subband 0, subband 1, . . . subband N−1). While FIG. 2 is described with reference to an SRS, similar subbands may be used for transmission of an uplink channel, such as PUSCH and/or PUCCH.

The UE may apply a same precoding for transmission of the SRS resource 202 within an individual subband but may use different precoding for transmission of the SRS resource 202 in different subbands. The precoding in different subbands may or may not be orthogonal. Note that the UE is not required to use different precoding for different subbands, and there may be instances in which the UE uses the same precoding for multiple subbands. However, the network may only be able to assume the same precoding is used within individual subbands and not across different subbands.

In an example, the frequency spectrum may be divided into multiple nominal subbands, which may be consecutive in the frequency domain. The actual subbands for SRS transmission may correspond to the subcarriers of the nominal subband that are included in the SRS resource 202. In some embodiments, the nominal subbands may have a same bandwidth (e.g., have the same amount of frequency subcarriers).

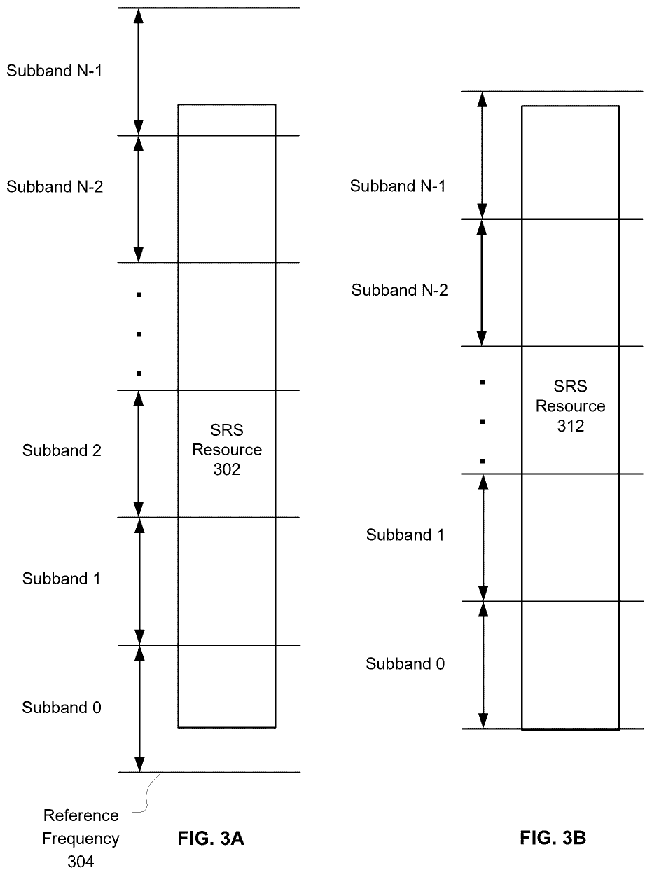

In some embodiments, the start of the first subband (subband 0) may be defined with respect to a reference frequency. The reference frequency may be configured for the UE by the network. FIG. 3A illustrates an example in accordance with some embodiments. As shown, an SRS resource 302 is divided across N subbands, with subband 0 starting at a reference frequency 304, which is outside of the frequency bandwidth of the SRS resource 302. Both subband 0 and subband N−1 are only partially overlapped with the SRS resource 302, and thus the corresponding actual subbands for SRS transmission have a smaller bandwidth than the subbands 1 to N−2.

Alternatively, the start of the first subband (subband 0) may be defined with respect to the lowest (or highest) subcarrier in the SRS resource. FIG. 3B illustrates an example in accordance with some embodiments. As shown, SRS resource 312 is divided across N subbands, with subband 0 starting at the lowest subcarrier of the SRS resource 312. Thus, the SRS resource is fully overlapped with subbands 0 to N−2, leaving only one actual subband with a smaller bandwidth. The scheme of FIG. 3B may result in one fewer subband or the same number of subbands, given the same subband bandwidth, than the scheme of FIG. 3A, e.g., depending on the spacing between the starting frequency of subband 0 and the reference frequency 304 in the scheme of FIG. 3A. However, the scheme of FIG. 3B may require additional signaling/processing overhead, since the subband boundaries for different UEs in a cell may be different.

While FIGS. 3A and 3B illustrate the configuration of subbands for SRS, a similar configuration (e.g., definition of the subband boundaries) may be used for an uplink channel, such as PUSCH and/or PUCCH.

In an example, network may configure the size of the subbands for uplink transmission, e.g., via configuration information provided to the UE. In one example, the subbands may be configured as a fraction of a bandwidth, such as the bandwidth of a UL component carrier, or a bandwidth of the uplink transmission (e.g., SRS, PUSCH, and/or PUCCH). For example, the configuration information received by the UE from the network may indicate a fractional value corresponding to the size of individual subbands. In another example, the configuration information may indicate a number of frequency domain resources included in individual subbands. For example, the configuration information may indicate a number of physical resource blocks (PRBs) and/or a number of subcarriers. Individual PRBs may include a fixed number of subcarriers.

In some embodiments, the subband size may be based on the bandwidth of the uplink transmission and/or uplink component carrier. For example, the subband size may be configured as a fraction of the bandwidth as described above. Alternatively, different ranges of bandwidth of the uplink transmission and/or uplink component carrier may be associated with a respective subband size (or a respective set of candidate subband sizes), e.g., according to a mapping table. The subband size may generally increase as the bandwidth of the uplink transmission and/or uplink component carrier increases.

In an example, the subband size may be configured by RRC signaling, semi-statically configured via medium access control (MAC)-control element (CE), and/or dynamically configured via DCI (e.g., the DCI that schedules the uplink transmission).

In some embodiments, a plurality of candidate subband sizes may be defined and the network may indicate one of the candidate subband sizes that is activated for an uplink transmission (e.g., SRS, PUSCH, and/or PUCCH). The plurality of candidate subband sizes may be pre-defined in the 3GPP TS(s) and/or configured by the network (e.g., via RRC signaling and/or MAC-CE). The activated subband size may be indicated, for example, via DCI and/or MAC-CE.

In some embodiments, a maximum number of subbands may be defined in addition to or instead of the candidate subband sizes. As the bandwidth of the active UL component carrier and/or SRS transmission increases, the candidate subband sizes and/or maximum number of subbands may increase or stay the same.

In some embodiments, the UE may transmit the SRS with the same number of layers (e.g., ports) in all subbands. For example, if the SRS is transmitted with a single SRS resource with multiple layers (e.g., ports), the SRS is transmitted with the same number of layers in all of the subbands. If the SRS is transmitted with multiple SRS resources each with a single layer (e.g., port), the UE transmits the SRS in every subband for each of the SRS resources.

In other embodiments, the SRS may be transmitted with different number of layers in different subbands. For example, if the SRS is transmitted with a single SRS resource with multiple layers, different SRS subbands can be transmitted with different numbers of layers. If the SRS is transmitted with multiple SRS resources each with a single layer, the UE may transmit the SRS in a subset of the subbands in one or more of the SRS resources (e.g., the UE may choose not to transmit the SRS in one or more subbands associated with an SRS resource).

As discussed above, the network may schedule an uplink transmission of the UE based on the SRS. For example, the uplink transmission may include a codebook-based PUSCH, non-codebook-based PUSCH, and/or PUCCH. The uplink transmission may be scheduled with frequency-selective precoding, e.g., with different precoding applied to different subbands of the uplink transmission. In some embodiments, the subbands of the uplink transmission may be the same as the subbands used for the SRS. In other embodiments, different subbands may be used for the uplink transmission than for the SRS. For example, the subbands used for the scheduled UL transmission may be referred to herein as UL channel subbands (e.g., PUSCH subbands and/or PUCCH subbands), while the subbands used for the SRS may be referred to as SRS subbands. In this case, the network may ensure that individual UL channel subbands overlap with one and only one SRS subband (e.g., so that the UE can identify the precoding to apply on the UL channel subband based on the overlapping SRS subband).

In an example, it may be required that all of the UL channel subbands may be scheduled with the same number of layers. In another example, different UL channel subbands may be scheduled with different numbers of layers.

When different UL channel subbands can be scheduled with different numbers of layers, the DMRS antenna port configuration may be based on the UL channel subband with the largest number of layers. For a UL channel subband with a smaller number of layers, the DMRS may be transmitted in the corresponding subset of the antenna ports. For example, for a UL channel subband with K layers, which is less than the largest number of layers (N) among the UL channel subbands, the DMRS is transmitted in the first K antenna ports of the DMRS antenna port configuration.

In an example, a non-codebook PUSCH may be scheduled with independent SRS resources/ports for respective PUSCH subbands. In some embodiments, one or more scheduling restrictions may be defined to reduce signaling overhead. For example, the scheduling may be restricted so that all PUSCH subbands contain the same number of layers and/or all SRS subbands contain the same number of layers. In one example, each SRS subband contains N layers, and each PUSCH subband can be scheduled with a maximum of R layers, where R≤N. With a total of M subbands, the number of bits needed for flexible precoding scheduling of the PUSCH may be:

$$⌈ {log}_{2} ( {\sum }_{r = 1}^{R} {C ( N , r )}^{M} ) ⌉$$

where

$$C ( N , r ) = \frac{N !}{( N - r ) ! r !}$$

is a combinatorial selection of r from N, and r is the number of layers that is scheduled (with a maximum value of R).

In some embodiments, the network may configure multiple sets (e.g., lists) of SRS resources/ports from which the network can select for scheduling the PUSCH. The individual sets may indicate respective SRS resources/ports that correspond to respective PUSCH subbands. In the message that schedules the PUSCH (e.g., a DCI), the network may indicate a selected set from among the configured sets to be applied by the UE for transmission of the PUSCH.

In another example, the same SRS resource/port may be scheduled for all PUSCH subbands of the non-codebook-based PUSCH. For example, in the message the schedules the PUSCH (e.g., a DCI), the network may indicate an SRS resource (e.g., via an SRS resource indicator (SRI)). The UE may apply the precoding used for the SRS subbands of the indicated SRS resource for transmission of the PUSCH.

For a codebook-based PUSCH, the UE may transmit the SRS with the same precoding across the bandwidth of the SRS (e.g., without applying frequency-selective precoding to the SRS). The UE may transmit the SRS in different SRS resources (e.g., in the time domain) with different precoding. The channel over which the SRS is transmitted may be frequency selective (e.g., with a frequency response that varies over the bandwidth of the SRS). Thus, the base station may determine different precoders for a PUSCH in different frequency subbands based on the received SRS(s). The base station may indicate the precoders to the UE via respective TPMIs.

In an example, a separate TPMI may be indicated for respective PUSCH subbands. The network may configure the PUSCH subbands as described above, e.g., with respect to SRS subbands. In some embodiments, a scheduling restriction may be implemented in which all the PUSCH subbands contain the same number of layers (e.g., to reduce signaling overhead).

As discussed above, subband information such as subband size and/or number of subbands for PUSCH transmission may be dynamically configured, e.g., via DCI and/or MAC-CE. Dynamic configuration of the subband information may be particularly beneficial for codebook-based PUSCH, however, dynamic configuration may also be used for non-codebook-based PUSCH and/or PUCCH. For example, the network may configure a smaller subband size for an uplink channel that is more frequency selective (e.g., as determined based on the SRS) and/or a larger subband size for an uplink channel that is less frequency selective.

In an example, the DCI that indicates the subband information may have a same size across multiple (e.g., all) numbers of subbands. In some instances, when a larger number of subbands is configured, the corresponding DCI may have lower resolution of the TPMI for individual subbands (e.g., lower number of bits per TPMI).

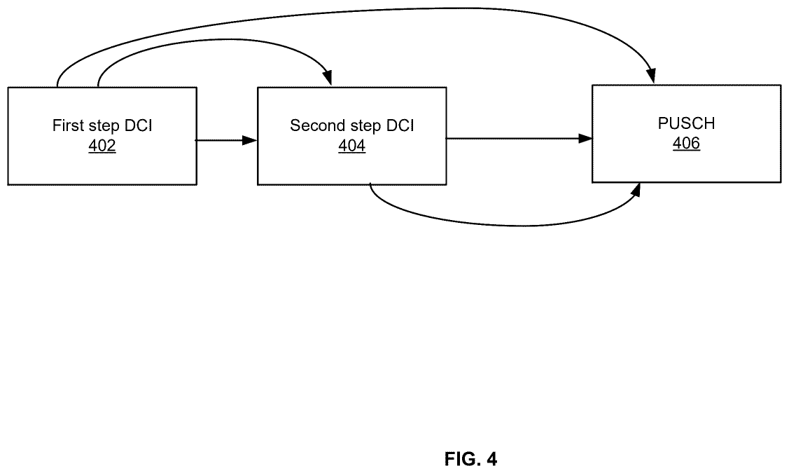

In another example, the size of the DCI may vary based on the number of subbands that are configured, e.g., the size of the DCI increases as the number of subbands increases. In some embodiments, a two-step DCI may be used to indicate the subband information. FIG. 4 illustrates an example of a two-step DCI that schedules a codebook-based PUSCH, in accordance with some embodiments.

As shown, the DCI includes a first step DCI 402 and a second step DCI 404 that schedule a PUSCH 406. The first step DCI 402 may have a fixed size, while the second step DCI 404 may have a variable size (e.g., based on the number of subbands). The first step DCI 402 may indicate the subband size and/or number of subbands for the PUSCH 406. The first step DCI 402 may further include other scheduling information, such as a resource allocation for the PUSCH 406 and/or the second step DCI 404. The second step DCI 404 may indicate a TPMI for respective subbands of the PUSCH 406. In some embodiments, the second step DCI 404 may further include other scheduling information associated with the PUSCH 406.

In some embodiments, the TPMIs for multiple subbands may be jointly encoded in the DCI. For example, for an individual PUSCH layer, the TPMI encoding may follow:

$${W}_{l} = {W}_{1}^{l} * {W}_{2}^{l} .$$

Wₗ refers to the precoding (beam forming) vector for PUSCH layer l for all the subbands. For example, each column of Wₗ represents the beam forming column vector for the corresponding subband.

$${W}_{1}^{l}$$

refers to the spatial basis selected for PUSCH layer l. The spatial basis may be selected from a discrete Fourier transform (DFT) matrix. In an example, each column of

$${W}_{1}^{l}$$

is one selected spatial basis.

$${W}_{2}^{l}$$

refers to a linear combination matrix with each column of

$${W}_{2}^{l}$$

representing the linear combination coefficient for the corresponding subband. In an example, only a subset of entries in

$${W}_{2}^{l}$$

need to be configured by the network, with the other entries assumed to be zero. For example, each column of

$${W}_{2}^{l}$$

may be a selection vector, with one entry of the column being a one and the rest being zero.

In another example, for an individual PUSCH layer, the joint TPMI encoding may follow:

$${W}_{l} = {W}_{1}^{l} * {W}_{2}^{l} * {W}_{f}^{l} .$$

As discussed above, Wₗ refers to the precoding (beam forming) vector for PUSCH layer/for all the subbands,

$${W}_{1}^{l}$$

refers to the spatial basis selected for PUSCH layer l, and

$${W}_{2}^{l}$$

refers to a linear combination matrix with each column of

$${W}_{2}^{l}$$

representing the linear combination coefficient for the corresponding subband.

$${W}_{f}^{l}$$

refers to the frequency basis selected for PUSCH layer l. The frequency basis may be selected from a DFT matrix. In an example, each row of

$${W}_{f}^{l}$$

may correspond to the one selected frequency basis.

With respect to PUCCH with frequency-selective precoding, the scheduling of the PUCCH and/or SRS may follow the embodiments discussed above with respect to PUSCH. In some instances, more than one PUCCH resource may be configured for the UE on an active component carrier. In some embodiments, a restriction may be implemented in which all of the PUCCH resources on the component carrier have the same subband size. In other embodiments, different PUCCH resources on the same component carrier may be configured with different subband sizes.

In some instances, a PUSCH and/or PUCCH may be transmitted by the UE prior to setting up (or completing setting up) an RRC connection with the network. In some embodiments, the PUSCH and/or PUCCH transmitted outside of RRC connected mode may not support frequency-selective precoding. The network may not know whether the UE supports frequency-selective precoding and/or have an opportunity to configure the frequency-selective precoding prior to the UE entering RRC connected state.

In other embodiments, frequency-selective precoding may be supported for PUSCH and/or PUCCH transmitted outside of RRC connected mode. For example, subband information (e.g., subband size and/or number of subbands) may be predefined (e.g., in the 3GPP TS(s)) for transmission of PUSCH and/or PUCCH outside of RRC connected mode. This enables the UE to transmit the PUSCH and/or PUCCH with frequency-selective precoding prior to receiving configuration information from the network to configure the subbands. However, this may require the UE to support frequency-selective precoding.

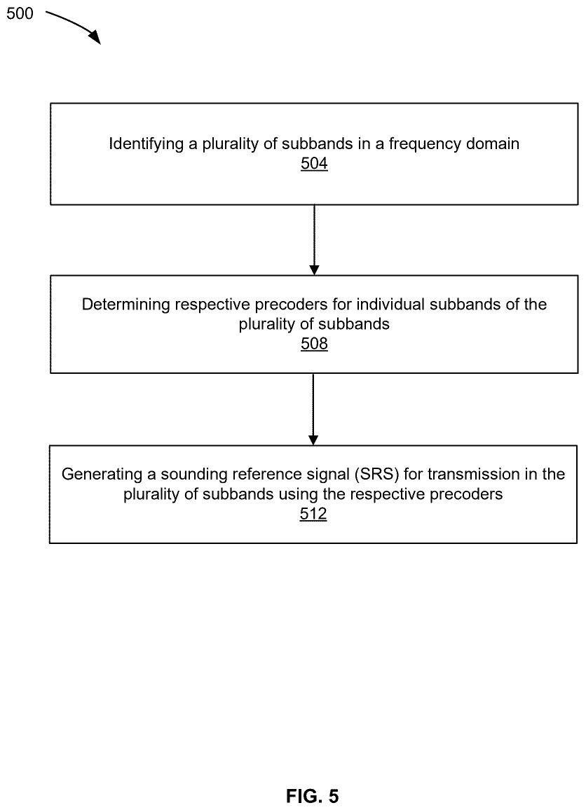

FIG. 5 illustrates an example of an operational flow/algorithmic structure 500 for frequency-selective uplink transmission, in accordance with some embodiments. The operational flow/algorithmic structure 500 can be implemented by a UE (e.g., performed by components thereof including, for example, an apparatus of the UE, where the apparatus includes processing circuitry; a modem is an example of such an apparatus). The UE can be any of the UEs described herein. In some embodiments, the operational flow/algorithmic structure 500 may be implemented by executing instructions stored in a tangible, non-transitory, computer-readable storage medium, such as a memory of the UE. While the operational flow/algorithmic structure 500 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 500 includes, at 504, identifying a plurality of subbands in a frequency domain. For example, the UE may receive configuration information from the network (e.g., a base station) to configure the plurality of subbands. In some embodiments, the configuration information may indicate a starting frequency of a first subband of the plurality of subbands (e.g., based on a reference frequency and/or a starting frequency of an uplink transmission). The configuration information may additionally or alternatively indicate a number of subbands included in the plurality of subbands, a number of PRBs included per individual subband of the plurality of subbands, and/or a number of subcarriers included per individual subband of the plurality of subbands.

The operational flow/algorithmic structure 500 may further include, at 508, determining respective precoders for individual subbands of the plurality of subbands. For example, the UE may determine a precoder for each of the individual subbands. The precoders may not be required to be orthogonal. Additionally, in some instances, the UE may determine the same precoder for more than one of the subbands (e.g., with at least two of the subbands having different precoders). In an example, for a channel with reciprocity such as with non-codebook-based communication, the UE may determine the respective precoders based on one or more measurements on downlink transmissions, such as CSI-RS, SSB, and/or another downlink reference signal. In some embodiments, the precoders may be determined in accordance with a restriction that requires all of the subbands to be transmitted with a same number of layers.

The operational flow/algorithmic structure 500 may further include, at 512, generating a sounding reference signal (SRS) for transmission in the plurality of subbands using the respective precoders. In an example, the SRS may be transmitted with the same number of layers in all of the subbands. In another example, the SRS may be transmitted with different numbers of layers in two or more of the subbands.

In an example, the UE may receive a DCI to schedule a non-codebook PUSCH for transmission on the plurality of subbands. The DCI may indicate respective SRS resources associated with the individual subbands of the plurality of subbands. In some embodiments, the UE may receive a configuration of multiple sets of SRS resources, and the DCI may indicate a first set of the multiple sets to use for the PUSCH.

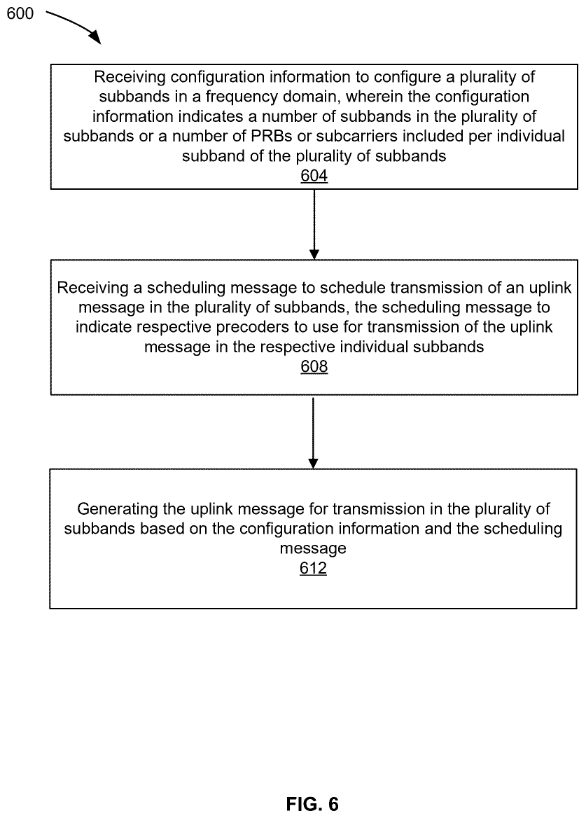

FIG. 6 illustrates another example of an operational flow/algorithmic structure 600 for frequency-selective uplink transmission, in accordance with some embodiments. The operational flow/algorithmic structure 600 can be implemented by a UE (e.g., performed by components thereof including, for example, an apparatus of the UE, where the apparatus includes processing circuitry; a modem is an example of such an apparatus). The UE can be any of the UEs described herein. In some embodiments, the operational flow/algorithmic structure 600 may be implemented by executing instructions stored in a tangible, non-transitory, computer-readable storage medium, such as a memory of the UE. While the operational flow/algorithmic structure 600 is described using steps in a specific sequence, it should be understood that the present disclosure contemplates that the described steps may be performed in different sequences than the sequence illustrated, and certain described steps may be omitted or not performed altogether. Further, one or more operations of the operational flow/algorithmic structure 600 can include one or more operations of the operational flow/algorithmic structure 500.

In an example, the operational flow/algorithmic structure 600 includes, at 604, receiving configuration information to configure a plurality of subbands in a frequency domain, wherein the configuration information indicates a number of subbands in the plurality of subbands or a number of PRBs or subcarriers included per individual subband of the plurality of subbands. For example, the configuration information may be received via RRC signaling, MAC-CE, and/or DCI. In some embodiments, the number of subbands or the number of subcarriers included per individual subband may be based on the bandwidth of an uplink transmission and/or uplink component carrier.

The operational flow/algorithmic structure 600 may further include, at 608, receiving a scheduling message to schedule transmission of an uplink message in the plurality of subbands, the scheduling message to indicate respective precoders to use for transmission of the uplink message in the respective individual subbands. In some embodiments, some or all of the configuration information (received at 604) may be included in the scheduling message. In an example, the scheduling message is a DCI. The DCI may have a fixed size or a variable size that varies based on the number of subbands. In an example, the DCI includes a first DCI part to indicate the number of subbands and a second DCI part to indicate the respective precoders. The first DCI part may schedule the second DCI part.

In an example, the scheduling message is to indicate the respective precoders based on a scheduling restriction that requires the PUSCH to be scheduled in all of the subbands with a same number of layers. In another example, the scheduling message is to schedule the uplink message with different numbers of layers in two or more of the individual subbands. A DMRS antenna port configuration may be based on a first subband that has a first number of layers that is the largest among the plurality of subbands. The UE may generate the DMRS for transmission in a second subband that has a second number of layers that is less than the first number, where the DMRS is transmitted in the second subband with the second number of antenna ports.

The operational flow/algorithmic structure 600 may further include, at 612, generating the uplink message for transmission in the plurality of subbands based on the configuration information and the scheduling message. The uplink message may include, for example, a codebook-based PUSCH, a non-codebook-based PUSCH, and/or a PUCCH. When the uplink message is a codebook-based PUSCH, the precoders may be indicated by respective TPMIs. In an example, the TPMIs are jointly encoded in the scheduling message. For example, the TPMIs may be indicated based on a multiplication of a first matrix that indicates a spatial basis for a layer of the PUSCH selected from a discrete Fourier Transform (DFT) matrix and a second matrix that is a linear combination matrix with respective columns indicating a linear combination coefficient for corresponding individual subbands of the plurality of subbands. In some embodiments, the TPMIs may be indicated based further on a third matrix that indicates a frequency basis for the layer of the PUSCH selected from another DFT matrix.

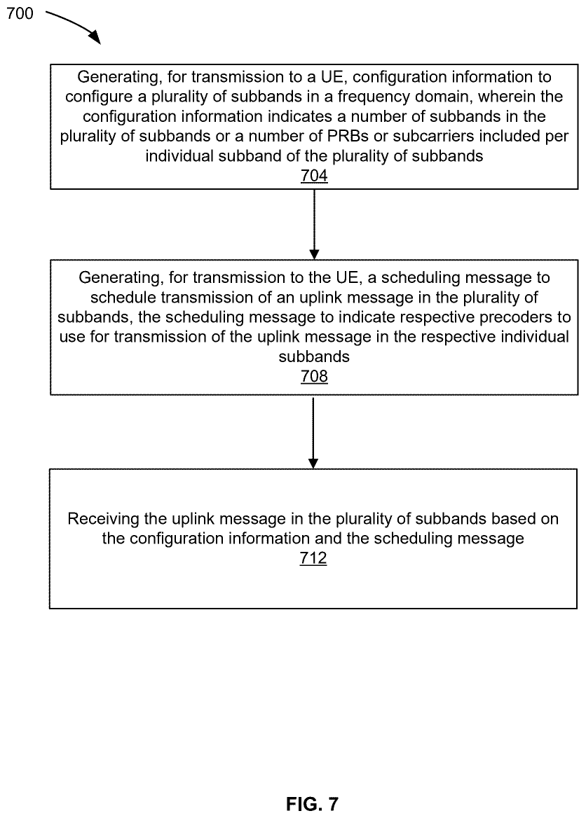

FIG. 7 illustrates another example of an operational flow/algorithmic structure 700 for frequency-selective uplink transmission, in accordance with some embodiments. The operational flow/algorithmic structure 700 can be implemented by a base station (e.g., performed by components thereof including, for example, an apparatus of the base station, where the apparatus includes processing circuitry; a modem is an example of such an apparatus). The base station can be any of the base stations described herein. In some embodiments, the operational flow/algorithmic structure 700 may be implemented by executing instructions stored in a tangible, non-transitory, computer-readable storage medium, such as a memory of the base station. While the operational flow/algorithmic structure 700 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 700 includes, at 704, generating, for transmission to a UE, configuration information to configure a plurality of subbands in a frequency domain, wherein the configuration information indicates a number of subbands in the plurality of subbands or a number of PRBs or subcarriers included per individual subband of the plurality of subbands. For example, the configuration information may be transmitted via RRC signaling, MAC-CE, and/or DCI. In some embodiments, the number of subbands or the number of subcarriers included per individual subband may be based on the bandwidth of an uplink transmission and/or uplink component carrier.

The operational flow/algorithmic structure 700 may further include, at 708, generating, for transmission to the UE, a scheduling message to schedule transmission of an uplink message in the plurality of subbands, the scheduling message to indicate respective precoders to use for transmission of the uplink message in the respective individual subbands. In some embodiments, some or all of the configuration information (transmitted at 704) may be included in the scheduling message. In an example, the scheduling message is a DCI. The DCI may have a fixed size or a variable size that varies based on the number of subbands. In an example, the DCI includes a first DCI part to indicate the number of subbands and a second DCI part to indicate the respective precoders. The first DCI part may schedule the second DCI part.

In an example, the scheduling message is to indicate the respective precoders based on a scheduling restriction that requires the PUSCH to be scheduled in all of the subbands with a same number of layers. In another example, the scheduling message is to schedule the uplink message with different numbers of layers in two or more of the individual subbands. A DMRS antenna port configuration may be based on a first subband that has a first number of layers that is the largest among the plurality of subbands. The base station may receive the DMRS in a second subband that has a second number of layers that is less than the first number, where the DMRS is received in the second subband with the second number of antenna ports.

The operational flow/algorithmic structure 700 may further include, at 712, receiving the uplink message in the plurality of subbands based on the configuration information and the scheduling message. The uplink message may include, for example, a codebook-based PUSCH, a non-codebook-based PUSCH, and/or a PUCCH. When the uplink message is a codebook-based PUSCH, the precoders may be indicated by respective TPMIs. In an example, the TPMIs are jointly encoded in the scheduling message. For example, the TPMIs may be indicated based on a multiplication of a first matrix that indicates a spatial basis for a layer of the PUSCH selected from a discrete Fourier Transform (DFT) matrix and a second matrix that is a linear combination matrix with respective columns indicating a linear combination coefficient for corresponding individual subbands of the plurality of subbands. In some embodiments, the TPMIs may be indicated based further on a third matrix that indicates a frequency basis for the layer of the PUSCH selected from another DFT matrix.

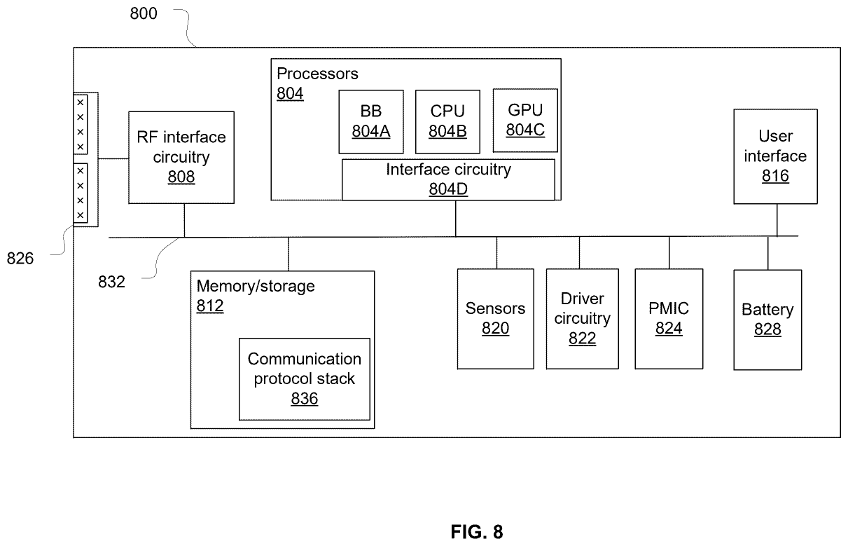

FIG. 8 illustrates a UE 800, in accordance with some embodiments. The UE 800 may be similar to and substantially interchangeable with any of the UEs described herein above. Particularly, the UE 800 can support frequency-selective uplink transmission as described herein.

Similar to that described above with respect to UE 104, the UE 800 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 800 may include processors 804, RF interface circuitry 808, memory/storage 812, user interface 816, sensors 820, driver circuitry 822, power management integrated circuit (PMIC) 824, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 832, which may represent any type of interface, input/output, bus (local, system, or expansion), transmission line, trace, optical connection, etc. that allows various circuit components (on common or different chips or chipsets) to interact with one another.

The processors 804 may include processor circuitry, such as baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 804A may also access group information from memory/storage 812 to determine search space groups in which a number of repetitions of a PDCCH may be transmitted.

The memory/storage 812 may include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 808 may include transceiver circuitry and a radio frequency front end module (RF FEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, control circuitry, etc.

In the receive path, the RF FEM may receive a radiated signal from an air interface via an antenna 850 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RF FEM. The RFEM may amplify the RF signal through a power amplifier prior to the signal being radiated across the air interface via the antenna 850.

In various embodiments, the RF interface circuitry 808 may be configured to transmit/receive signals in a manner compatible with NR access technologies.

The antenna 850 may include a number of antenna elements that each convert electrical signals into radio waves to travel through the air and to convert received radio waves into electrical signals. The antenna elements may be arranged into one or more antenna panels. The antenna 850 may have antenna panels that are omnidirectional, directional, or a combination thereof to enable beamforming and multiple input, multiple output communications. The antenna 850 may include microstrip antennas, printed antennas fabricated on the surface of one or more printed circuit boards, patch antennas, phased array antennas, etc. The antenna 850 may have one or more panels designed for specific frequency bands including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 800 may power down for brief intervals of time and thus save power. If there is no data traffic activity for an extended period of time, then the UE 800 may transition off to an RRC_Idle state, where it disconnects from the network and does not perform operations, such as channel quality feedback, handover, etc. The UE 800 goes into a very low power state and it performs paging where again it periodically wakes up to listen to the network and then powers down again. The UE 800 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 828 may power the UE 800, although in some examples the UE 800 may be mounted deployed in a fixed location and may have a power supply coupled to an electrical grid. The battery 828 may be a lithium-ion battery, a metal-air battery, such as a zinc-air battery, an aluminum-air battery, a lithium-air battery, and the like. In some implementations, such as in vehicle-based applications, the battery 828 may be a typical lead-acid automotive battery.

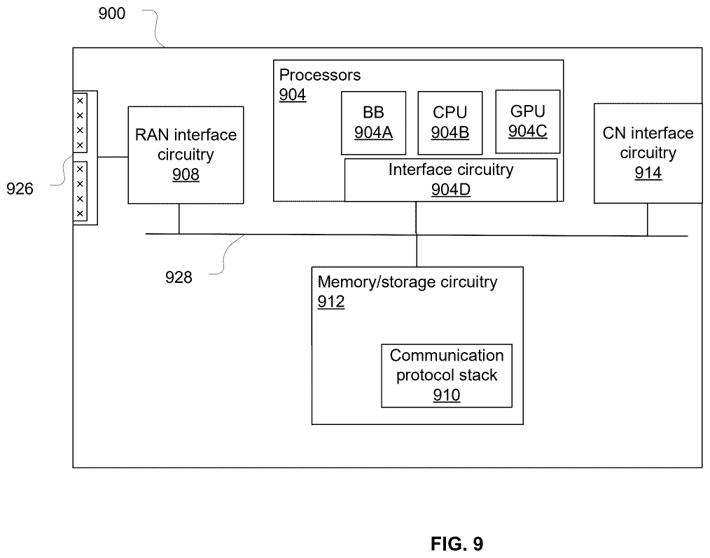

FIG. 9 illustrates a base station 900, in accordance with some embodiments. The base station 900 may be similar to and substantially interchangeable with the base station 108 of FIG. 1 and other base stations described herein above. Particularly, the base station 900 can support frequency-selective uplink transmission, as described herein.

The base station 900 may include processors 904, RAN interface circuitry 908, core network (CN) interface circuitry 912, and memory/storage circuitry 916.

The components of the base station 900 may be coupled with various other components over one or more interconnects 928.

The processors 904, RAN interface circuitry 908, memory/storage circuitry 916 (including communication protocol stack 910), antenna 950, and interconnects 928 may be similar to like-named elements shown and described with respect to FIG. 8.

The CN interface circuitry 912 may provide connectivity to a core network, for example, a Fifth Generation Core network (5GC) using a 5GC-compatible network interface protocol, such as carrier Ethernet protocols, or some other suitable protocol. Network connectivity may be provided to/from the base station 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes a method comprising: identifying a plurality of subbands in a frequency domain; determining respective precoders for individual subbands of the plurality of subbands; and generating a sounding reference signal (SRS) for transmission in the plurality of subbands using the respective precoders.

Example 2 includes the method of example 1 or some other example herein, further comprising receiving configuration information from a network to configure the plurality of subbands.

Example 3 includes the method of example 2 or some other example herein, wherein the configuration information includes a reference frequency to indicate a starting frequency of a first subband of the plurality of subbands.

Example 4 includes the method of example 2 or some other example herein, wherein the configuration information indicates a fraction of a bandwidth that corresponds to the respective individual subbands, a number of physical resource blocks (PRBs), or a number of subcarriers included in the respective individual subbands.

Example 5 includes the method of example 1 or some other example herein, wherein the SRS has a different number of layers in two or more of the plurality of subbands.

Example 6 includes the method of example 1 or some other example herein, wherein the precoders are determined in accordance with a restriction that requires all of the subbands to be transmitted with a same number of layers.

Example 7 includes the method of example 1 or some other example herein, further comprising: receiving a downlink control information (DCI) to schedule a non-codebook-based physical uplink shared channel (PUSCH) for transmission on the plurality of subbands, wherein the DCI indicates respective SRS resources associated with the individual subbands of the plurality of subbands.

Example 8 includes the method of example 7 or some other example herein, further comprising receiving a configuration of multiple sets of SRS resources, wherein the DCI indicates a first set of the multiple sets to use for the PUSCH.

Example 9 includes an apparatus comprising processing circuitry to receive configuration information to configure a plurality of subbands in a frequency domain, wherein the configuration information indicates a number of subbands in the plurality of subbands or a number of physical resource blocks (PRBs) or subcarriers included per individual subband of the plurality of subbands; receive a scheduling message to schedule transmission of an uplink message in the plurality of subbands, the scheduling message to indicate respective precoders to use for transmission of the uplink message in the respective individual subbands; and generate the uplink message for transmission in the plurality of subbands based on the configuration information and the scheduling message. The apparatus may further include interface circuitry coupled to the processing circuitry to enable communication.

Example 10 includes the apparatus of example 9 or some other example herein, wherein the configuration information is included in the scheduling message.

Example 11 includes the apparatus of example 10 or some other example herein, wherein the scheduling message includes a first downlink control information (DCI) part and a second DCI part, the first DCI part to indicate the number of subbands and the second DCI part to indicate the respective precoders.

Example 12 includes the apparatus of example 9 or some other example herein, wherein the scheduling message is to indicate the respective precoders based on a scheduling restriction that requires the PUSCH to be scheduled in all of the subbands with a same number of layers.

Example 13 includes the apparatus of example 9 or some other example herein, wherein the scheduling message is to schedule the uplink message with different numbers of layers in two or more of the individual subbands, wherein a demodulation reference signal (DMRS) antenna port configuration is based on a first subband that has a first number of layers that is the largest among the plurality of subbands, and wherein the processing circuitry is further to: generate a DMRS for transmission in a second subband that has a second number of layers that is less than the first number, wherein the DMRS is transmitted in the second subband with the second number of antenna ports.

Example 14 includes the apparatus of example 9 or some other example herein, wherein the uplink message is a codebook-based physical uplink shared channel (PUSCH), a non-codebook-based PUSCH, or a physical uplink control channel (PUCCH).

Example 15 includes the apparatus of example 9 or some other example herein, wherein the precoders are indicated by respective transmit precoding matrix indicators (TPMIs) and wherein the TPMIs for the plurality of subbands are jointly encoded in the scheduling message.

Example 16 includes the apparatus of example 15 or some other example herein, wherein the TPMIs are indicated based on a multiplication of a first matrix that indicates a spatial basis for a layer of the PUSCH selected from a discrete Fourier Transform (DFT) matrix and a second matrix that is a linear combination matrix with respective columns indicating a linear combination coefficient for corresponding individual subbands of the plurality of subbands.

Example 17 includes the apparatus of example 16 or some other example herein, wherein the DFT matrix is a first DFT matrix, and wherein the TPMIs are indicated based further on a third matrix that indicates a frequency basis for the layer of the PUSCH selected from a second DFT matrix.

Example 18 includes a method comprising: generating, for transmission to a user equipment (UE), configuration information to configure a plurality of subbands in a frequency domain, wherein the configuration information indicates a number of subbands in the plurality of subbands or a number of physical resource blocks (PRBs) or subcarriers included per individual subband of the plurality of subbands; generating, for transmission to the UE, a scheduling message to schedule transmission of an uplink message in the plurality of subbands, the scheduling message to indicate respective precoders to use for transmission of the uplink message in the respective individual subbands; and receiving the uplink message in the plurality of subbands based on the configuration information and the scheduling message.

Example 19 includes the method of example 18 or some other example herein, wherein the configuration information is included in the scheduling message, and wherein the scheduling message includes a first downlink control information (DCI) part and a second DCI part, the first DCI part to indicate the number of subbands and the second DCI part to indicate the respective precoders.

Example 20 includes the method of example 18 or some other example herein, wherein the precoders are indicated by respective transmit precoding matrix indicators (TPMIs) and wherein the TPMIs for the plurality of subbands are jointly encoded in the scheduling message.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying a plurality of subbands in a frequency domain;
determining respective precoders for individual subbands of the plurality of subbands; and
generating a sounding reference signal (SRS) for transmission in the plurality of subbands using the respective precoders.

2. The method of claim 1, further comprising receiving configuration information from a network to configure the plurality of subbands.

3. The method of claim 2, wherein the configuration information includes a reference frequency to indicate a starting frequency of a first subband of the plurality of subbands.

4. The method of claim 2, wherein the configuration information indicates a fraction of a bandwidth that corresponds to the respective individual subbands, a number of physical resource blocks (PRBs), or a number of subcarriers included in the respective individual subbands.

5. The method of claim 1, wherein the SRS has a different number of layers in two or more of the plurality of subbands.

6. The method of claim 1, wherein the precoders are determined in accordance with a restriction that requires all of the subbands to be transmitted with a same number of layers.

7. The method of claim 1, further comprising:
receiving a downlink control information (DCI) to schedule a non-codebook-based physical uplink shared channel (PUSCH) for transmission on the plurality of subbands, wherein the DCI indicates respective SRS resources associated with the individual subbands of the plurality of subbands.

8. The method of claim 7, further comprising receiving a configuration of multiple sets of SRS resources, wherein the DCI indicates a first set of the multiple sets to use for the PUSCH.

9. An apparatus comprising:
processing circuitry to:
receive configuration information to configure a plurality of subbands in a frequency domain, wherein the configuration information indicates a number of subbands in the plurality of subbands or a number of physical resource blocks (PRBs) or subcarriers included per individual subband of the plurality of subbands;
receive a scheduling message to schedule transmission of an uplink message in the plurality of subbands, the scheduling message to indicate respective precoders to use for transmission of the uplink message in the respective individual subbands; and
generate the uplink message for transmission in the plurality of subbands based on the configuration information and the scheduling message; and
interface circuitry coupled to the processing circuitry to receive the configuration information.

10. The apparatus of claim 9, wherein the configuration information is included in the scheduling message.

11. The apparatus of claim 10, wherein the scheduling message includes a first downlink control information (DCI) part and a second DCI part, the first DCI part to indicate the number of subbands and the second DCI part to indicate the respective precoders.

12. The apparatus of claim 9, wherein the scheduling message is to indicate the respective precoders based on a scheduling restriction that requires the PUSCH to be scheduled in all of the subbands with a same number of layers.

13. The apparatus of claim 9, wherein the scheduling message is to schedule the uplink message with different numbers of layers in two or more of the individual subbands, wherein a demodulation reference signal (DMRS) antenna port configuration is based on a first subband that has a first number of layers that is the largest among the plurality of subbands, and wherein the processing circuitry is further to:
generate a DMRS for transmission in a second subband that has a second number of layers that is less than the first number, wherein the DMRS is transmitted in the second subband with the second number of antenna ports.

14. The apparatus of claim 9, wherein the uplink message is a codebook-based physical uplink shared channel (PUSCH), a non-codebook-based PUSCH, or a physical uplink control channel (PUCCH).

15. The apparatus of claim 9, wherein the precoders are indicated by respective transmit precoding matrix indicators (TPMIs) and wherein the TPMIs for the plurality of subbands are jointly encoded in the scheduling message.

16. The apparatus of claim 15, wherein the TPMIs are indicated based on a multiplication of a first matrix that indicates a spatial basis for a layer of the PUSCH selected from a discrete Fourier Transform (DFT) matrix and a second matrix that is a linear combination matrix with respective columns indicating a linear combination coefficient for corresponding individual subbands of the plurality of subbands.

17. The apparatus of claim 16, wherein the DFT matrix is a first DFT matrix, and wherein the TPMIs are indicated based further on a third matrix that indicates a frequency basis for the layer of the PUSCH selected from a second DFT matrix.

18. A method comprising:
generating, for transmission to a user equipment (UE), configuration information to configure a plurality of subbands in a frequency domain, wherein the configuration information indicates a number of subbands in the plurality of subbands or a number of physical resource blocks (PRBs) or subcarriers included per individual subband of the plurality of subbands;
generating, for transmission to the UE, a scheduling message to schedule transmission of an uplink message in the plurality of subbands, the scheduling message to indicate respective precoders to use for transmission of the uplink message in the respective individual subbands; and
receiving the uplink message in the plurality of subbands based on the configuration information and the scheduling message.

19. The method of claim 18, wherein the configuration information is included in the scheduling message, and wherein the scheduling message includes a first downlink control information (DCI) part and a second DCI part, the first DCI part to indicate the number of subbands and the second DCI part to indicate the respective precoders.

20. The method of claim 18, wherein the precoders are indicated by respective transmit precoding matrix indicators (TPMIs) and wherein the TPMIs for the plurality of subbands are jointly encoded in the scheduling message.
